(19) United States
(12) Patent Application Publication
(10) Pub. No.: US 2009/0254987 A1
(43) Pub. Date: Oct. 8, 2009

(54) INFORMATION PROCESSING APPARATUS, COMPUTER-READABLE RECORDING MEDIUM, OUTPUT CONTROL METHOD AND SYSTEM

(75) Inventors: Hideyuki SUGITA, Kawasaki (JP); Minoru Shiragami, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/412,761

(22) Filed: Mar. 27, 2009

(30) Foreign Application Priority Data
Apr. 4, 2008 (JP) 2008-97659

(51) Int. Cl. G06F 21/20

(52) U.S. Cl. 726/17

(57) ABSTRACT

An output control apparatus and method in which at least either a first access authority at a first level or a second access authority at a second level that is higher than the first level may be set according to a user. The method includes referring to a first storage unit that stores authority information indicating an access authority level of a current user, selecting composing information stored in a second storage unit in association with the user to which the access authority is set from the second storage unit when the authority information indicates the first access authority, composing the selected composing information and output target data generated based on an output instruction by the current user, and outputting composed data of processing results by the composing.

### CROSS-REFERENCE TO RELATED APPLICATIONS

This application is based upon and claims the benefit of priority of the prior Japanese Patent Application No. 2008-97659, filed on Apr. 4, 2008 the entire contents of which are incorporated herein by reference.

### BACKGROUND

1. Field

The embodiment(s) discussed herein relate to, for example, an information processing apparatus such as a personal computer, an output control device, etc.

2. Description of the Related Art

A personal computer as an information processing apparatus manages a user including information thereof on an operating system (hereinafter referred to as OS) that works thereon. Furthermore, the OS manages the user by setting access authority to resources such as usable functions and files according to each user. Based on the user ID entered by a user at the time of login, the OS specifies access authority information that is managed according to the user. The OS controls the access to the resource by a login user based on the access authority information. The access authority includes, for example, an administrator authority (administrator) granting access authority to all resources, and a user authority having access authority limited at a level that is lower than the administrator authority. The OS may set the access authority at a plurality of levels as well as the administrator authority and the user authority depending on the OS type.

In recent years, for the purpose of preventing leakage of confidential information, composing information is added to a confidential document when the confidential document is printed. Watermark printing (referred to as pattern printing) is known as a printing method for adding composing information. For the watermark printing, the background that includes patterns or texts that are unnoticeable to humans in the printing of the original is added to a document as an output target. When the printing original printed by the watermark printing is copied by a copy machine or the like, the patterns or the texts emerge over the copy. As described above, the watermark printing is a technique that may distinguish the printing original from the copy and prevent leakage of confidential information.

Furthermore, as a printing method for urging prevention of leakage of confidential information or handling caution of confidential information, header/footer printing and stamp printing are known. The header/footer printing is a technique for printing a specified text in a position (header/footer) on a printing paper that is out of the area in which an output target text is printed. The stamp printing is a technique for printing a specified text or mark on an arbitrary position of a printing paper. The stamp printing is different from the watermark printing in that printing of the original is provided in a state humans recognize the text or the mark.

As a printing method for adding composing information to an output target, Japanese Laid-open Patent Publication No. 2001-014127 discusses a technique that a printer driver performs overlay printing. And Japanese Laid-open Patent Publication No. 2005-166033 discusses a technique for adding composed data corresponding to a confidential section when a confidential document is printed.

In general, a user who gives a printing instruction of a document selects whether or not to compose and print composing information depending on a document to be printed. The user also selects the composing information to be used. Accordingly, the user may print confidential information without adding the composing information because of user's forgetting or bothersome burden of selecting operation of the composing information. Such a situation is not preferable in view of calling attention concerning prevention of leakage of confidential information and handling of printed matters.

### SUMMARY

According to an embodiment of the invention, an information processing apparatus in which at least either a first access authority at a first level or a second access authority at a second level that is higher than the first level may be set according to a user is provided. The information processing apparatus includes a first storage unit that stores authority information indicating an access authority level of a current user, a second storage unit that stores composing information in association with a user, a selecting unit that refers to the authority information stored in the first storage unit and selects the composing information stored in the second storage unit in association with the user to which the second access authority is set when the authority information indicates the first access authority, a composing unit that composes the composing information selected by the selecting unit and output target data generated based on an output instruction by the current user, and an outputting unit that outputs composed data of processing results by the composing unit.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is an overview configuration diagram of an information processing apparatus according to an embodiment of the present invention;

FIG. 2 is a processing flowchart by an information processing apparatus according to an embodiment;

FIG. 3 is a diagram illustrating an example of hardware of an information processing apparatus according to an embodiment;

FIG. 4 is a diagram illustrating an example of a software configuration operating in an information processing apparatus according to an embodiment;

FIG. 5 is a processing flowchart concerning print setting in an information processing apparatus according to an embodiment;

FIG. 6 is a diagram illustrating a data structure of composing information;

FIG. 7 is an example of setting screen used for print setting under an administrator authority;

FIG. 8 is an example of setting screen used for print setting under an administrator authority;

FIG. 9 is another example of setting screen used for print setting under an administrator authority;

FIG. 10 is an example of setting screen used for print setting under a user authority;

FIG. 11 is an example of setting screen used for print setting under a user authority; and

FIG. 12 is a configuration diagram of a configuration of a system according to other embodiments.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

With reference to accompanying diagrams, an embodiment of the present invention will be described below. The following configuration of the embodiment is an example. The present invention is not limited to this configuration of the embodiment.

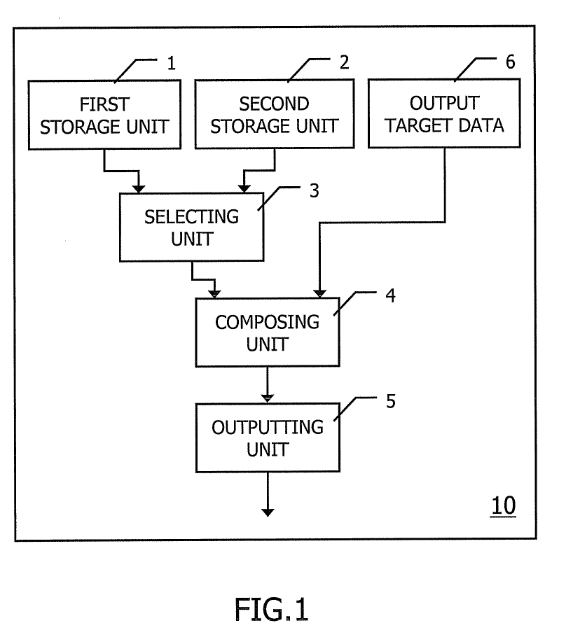

FIG. 1 is an overview configuration diagram of an information processing apparatus according to an embodiment of the present invention. As illustrated in FIG. 1, an information processing apparatus 10 of an embodiment includes a first storage unit 1, a second storage unit 2, a selecting unit 3, a composing unit 4, and an outputting unit 5. The information processing apparatus 10 manages a user by setting access authority to resource(s) such as a usable function, file corresponding to each user, etc. The information processing apparatus 10 specifies access authority information managed in accordance with the user based on the user ID entered at the time of login, and then controls the access to the resource by the logged user based on the access authority information. The information processing apparatus 10 of an embodiment has a configuration in which either the access authority at a first level or the access authority at a second level that is higher than the first level may be set according to the user.

The first storage unit 1 stores authority information indicating the access authority level set by a current user of the information processing apparatus 10. The second storage unit 2 stores composing information corresponding to the user. The storage unit 1 and the second storage unit 2 may be separate storage devices, and also may be achieved using the same storage device.

The selecting unit 3 refers to the authority information stored in the first storage unit 1. If the access authority level indicated by the authority information is the first level, the selecting unit 3 selects the composing information stored in the second storage unit 2 corresponding to the user to which the access authority level is set to the second level.

The composing unit 4 composes the composing information selected by the selecting unit 3 and output target data 6 that is generated based on an output instruction by the current user. The outputting unit 5 outputs the composed data of processing results by the composing unit 4.

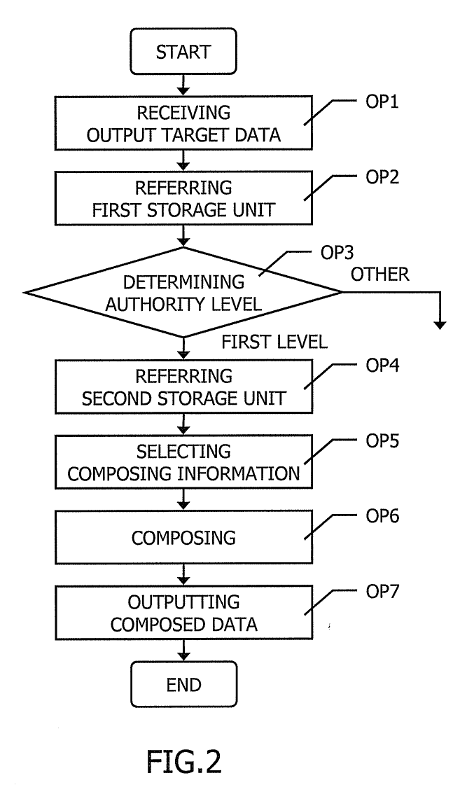

FIG. 2 is a processing flowchart of an information processing apparatus according to an embodiment. By the above-described configuration condition(s) that include the information processing apparatus 10, the following processing illustrated in FIG. 2 is performed.

The selecting unit 3 accesses the first storage unit 1 when the output target data 6 is received as a trigger (at OP 1). The selecting unit 3 refers to the authority information corresponding to the current user of the information processing apparatus 10 stored in the first storage unit 1 (at OP 2).

The selecting unit 3 determines the access authority level of the authority information acquired by the reference (at OP 3). If the access authority level is the first level, the selecting unit 3 accesses the second storage unit 2 and selects the composing information specified by a user (for example, administrator) to which the access authority at the second level is set (at OP 4 and at OP 5).

The composing unit 4 receives and composes the output target data 6 and the composing information selected by the selecting unit 3 to generate composed data (at OP 6). The outputting unit 5 transmits the composed data, generated by the composing unit 4 for example, to a given output device (at OP 7).

In OP 3 described above, when the access authority level is other than the first level, the selecting unit 3, the composing unit 4, and the outputting unit 5 perform processing corresponding to the specification by the current user. When there is an access authority level positioned between the first level and the second level, it is possible to employ either the same handling as the first level or the same handling as the second level.

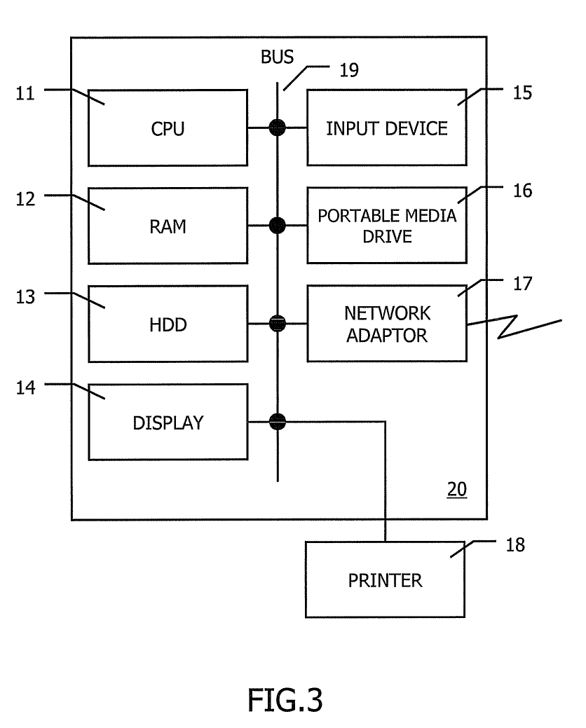

FIG. 3 is a diagram illustrating an example of hardware of an information processing apparatus according to an embodiment. FIG. 3 illustrates main hardware of a personal computer 20 as an example of information processing apparatus. As illustrated in FIG. 3, the personal computer 20 includes a central processing unit (CPU) 11, a main memory (RAM) 12, a hard disk drive (HDD) 13, a display 14, an input device 15, a portable media drive 16, and a network adaptor 17. Furthermore, a printer 18 is connected to the personal computer 20.

The CPU 11 operates and controls the personal computer 20 by performing, for example, various device driver(s), which include a BIOS (Basic Input/Output System) stored in EP-ROM (not shown), an OS (Operating System) stored in the HDD 13, and device drivers that include a printer driver, and application programs.

Furthermore, the CPU 11 performs various processing by reading out these programs from the HDD 13, and then loads these programs on the RAM 12 when performing this OS, these device drivers, and these application programs.

The input device 15 is, for example, a keyboard or a mouse. The input device 15, for example, is used when a user performs setting operation and processing instruction by using a screen displayed in the display 14. The display 14 displays processing results of various programs.

The portable media drive 16 as an auxiliary storage device accesses a portable media. Any type of portable media is applicable. The CPU 11 accesses the portable media loaded to the potable media drive 16 when a processing instruction of a user is given or a given processing result is given as a trigger, and then reads out the various programs and data stored in the portable media and stores the various programs and data in the portable media.

The network adaptor 17 is used to perform transmission and reception of data between the personal computer 20 and another device through a communication line.

The printer 18 may be connected with the personal computer 20 by a given interface such as a Universal Serial Bus (USB) through a cable. The printer 18 receives print data (composed data) from the printer driver described below operating on the personal computer 20, and then prints the print data on a paper. An embodiment is described indicating that the printer 18 is directly connected to the personal computer 20 by a cable. The printer 18 may be directly connected to the communication line and also may be connected to another device connected to the communication line. In these cases, the personal computer 20 gives a printing request to the printer 18 that employs a connection mode through the communication line by using the network adaptor 17.

The first storage unit 1 illustrated in FIG. 1 corresponds to the RAM 11, the HDD 13, or a portable media, for example. The second storage unit 2 illustrated in FIG. 1 corresponds to a non-volatile storage device such as the HDD 13 or a potable media, for example. The selecting unit 3, the composing unit 4, and the outputting unit 5 illustrated in FIG. 1 may be achieved by a program executed in the CPU 11, for example. An example of this program is the printer driver described below. While some process(es) or operation(s) are described as being implemented via a program, the present invention is not limited to any particular configuration or implementation. For example, any of operation(s) disclosed herein may be implemented via a program, a general purpose or special machine, etc.

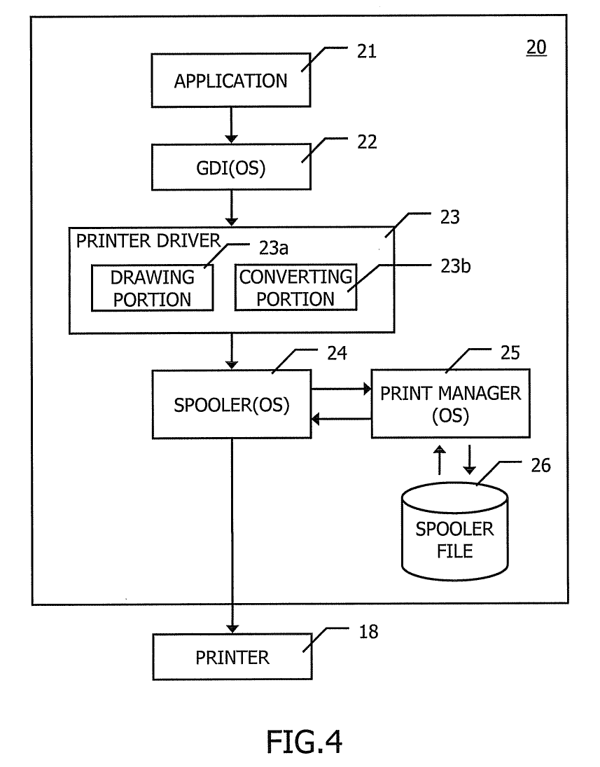

FIG. 4 is a diagram illustrating an example of software configuration operating in an information processing apparatus according to an embodiment. The personal computer 20 illustrated in FIG. 3 as an example of information processing apparatus is an example of hardware used to construct software implementations. Each program is performed in the CPU 11. This example explains processing content(s) by a main program related to a printing processing. The main program related to the printing processing in this example is an application program 21, an OS, a printer driver 23.

The application program 21 is an application such as, for example, a document preparation program or a Web browser. The application program 21 supplies a print image of the data to be printed to the OS by using an Application Program Interface (API) of Graphic Device Interface (GDI).

The OS includes a GDI 22, a spooler 24, and a print manager 25. The GDI 22 is a Graphic Device Interface that handles an output device such as a display and a printer. The GDI 22 receives, from the application program 21, the print image indicating a printing instruction and the print content by the above-described API. The spooler 24 is a program that temporary stores the print data to be output to a printer as a spooler (spool) file 26. The print manager 25 stores the print data, supplied from the spooler 24, in the spool file 26, and provides the print data, read out from the spool file 26 according to a processing state of printing job, to the printer 18 via the spooler 24.

The printer driver 23 includes a drawing portion 23a and a converting portion 23b. The drawing portion 23a receives the print image from the application program 21 via the GDI, and develops the print image into, for example, bit map data by page in the RAM 12 or the HDD 13. When composing processing for composing the data to be printed of the watermark printing and the like and the composing information is specified, the drawing portion 23a further develops the print image into, for example, bit map data in the RAM 12 or the HDD 13 based on the composing information. The converting portion 23b converts the generated bit map data into print data according to the printer 18, and transmits the bit map data to the spooler 24. When the above-described composing processing is specified, the converting portion 23b composes the bit map image of the print image and the bit map data of the composing information, and converts the data into print data. This composing processing performs composition of data by using a dot corresponding to each bit map data. The composing processing changes the processing content(s) depending on the specified printing function. For example, if the watermark printing is specified, the composing processing composes logical sum of the background in the print image and the data of the composing information. For example, when the header/footer printing or the stamp printing is specified, the compositing processing composes logical sum of the print image and the data of the composing information on the whole surface of one page. Although particular examples such as watermark printing, header/footer printing, etc., are discussed herein, the present invention is not limited thereto and may include any technique of ensuring data integrity by controlling output target of data.

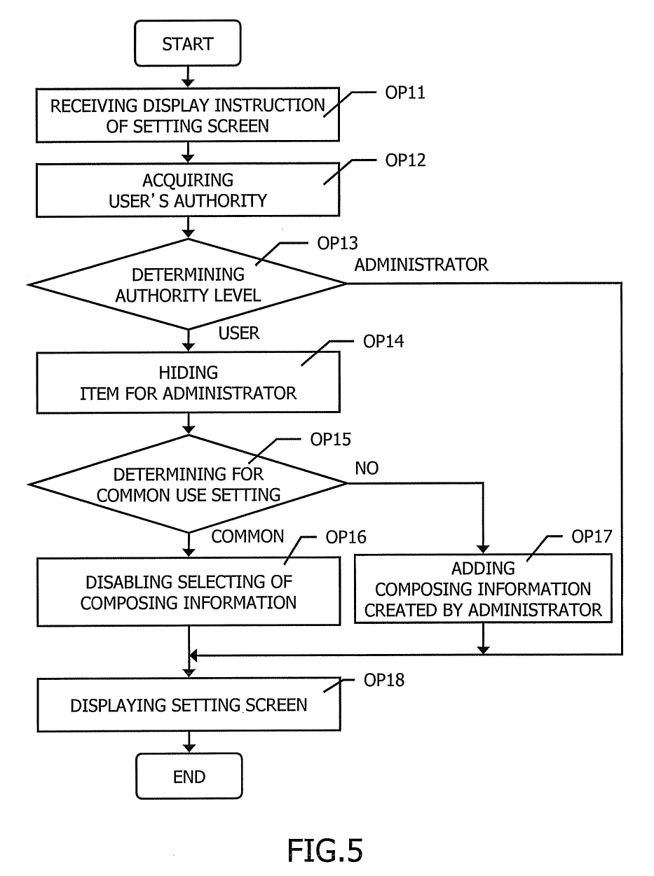

FIG. 5 is a processing flowchart related to print setting in an information processing apparatus according to an embodiment. This processing flowchart is processing content performed, for example, by the printer driver 23. The present processing flowchart describes administrator authority and user authority as two access authority levels. However, the embodiment is not limited to these two types of embodiments described above.

The printer driver 23 receives a display instruction of a setting screen by operation using the input device 15 operated by a user (at OP 11).

The printer driver 23 acquires the authority information of the current user managed by the OS according to reception of the display instruction of the setting screen (at OP 12). This authority information is stored in an operation management file by the OS as corresponding information of identification information indicating the user ID and authority level corresponding to the user.

The printer driver 23 determines the access authority level of the current user based on the acquired authority information (at OP 13). When it is determined that the current user is a user to which the administrator authority is set, the printer driver 23 displays the setting screen in a state that all the setting information may be set (at OP 18). For reference at the time of processing by the printer driver 23, the content set in this setting screen is stored as, for example, a setting file in the HDD 13 in association with each setting item of the setting screen. The printer driver 23 refers to the setting file, and displays the setting screen showing the display content corresponding to the setting content to each setting item. This setting file is generated for each user. The printer driver 23 refers to the setting file according to the logged user. This setting file includes the composing information created by this user. That is, when it is determined that the current user is a user to which the administrator authority is set in OP 13, the setting screen displayed in OP 18 displays the composing information created by the user as the administrator. If the composing information is in a mode that may be uniquely specified from the user information, the composing information may be filed in a different file from the setting file.

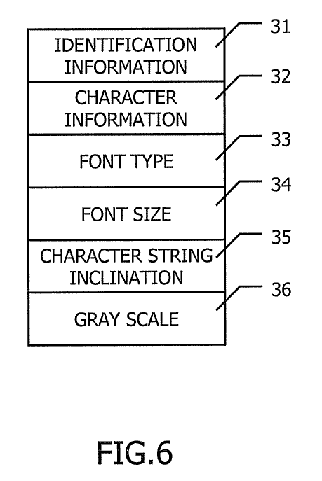

FIG. 6 is a diagram illustrating a data structure of composing information. This composing information is information used for watermark printing and includes an identification information 31, a character information 32, a font type 33, a font size 34, a character string inclination 35, and a gray scale 36. The identification information is information to identify the composing information, for example, an identifier such as a name added to the composing information. The character information 32 is a character content as information that appears on a copy by copying the printing original. The font type 33 is a font type at the time of printing the character content indicated by the character information 32 on a paper. The font size 34 is a font size at the time of printing the character content on a paper. The character string inclination 35 is information of the inclination to the standard and is indicated by angle at the time of printing the character content on a paper. Here, the standard may be in a vertical direction to a paper carrying direction. The gray scale 36 is percent information indicating print density at the time of printing the character content. A value of the print density may be an arbitrary value from 0 to 100. The drawing portion 23a of the printer driver 23 refers to the composing information corresponding to the identification information specified in the setting screen, and generates bit map data of the composing information based on the information content.

The setting content may be recorded in one file in a state that the setting content for each user is identified in such a way that the setting file may not be a different file for each user.

On the other hand, when the current user is determined to be a user to which the user authority is set, the printer driver 23 hides an administrator setting item in the setting screen (at OP 14). This processing doesn't hide the administrator setting item, and may have the processing content that sets such an item to unselectable.

After that, the printer driver 23 determines whether or not the composing information in which the administrator authority is set is set to be commonly used by users (at OP 15). The information on this setting is stored in, for example, the management file handled by the printer driver 23 stored in the HDD 13. If the composing information is commonly used by users, the printer driver 23 stores, in a management file, the information indicating that the composing information is commonly used by users. On the other hand, if the composing information is not commonly used by users, the printer driver 23 stores, in the management file, the information indicating that the composing information is not commonly used by users. This information may be stored in a setting file instead of a management file. In this case, the printer driver 23 accesses the setting file of the user to which the administrator authority is set, and may refer to the setting information corresponding to this setting item. As described above, even when a setting file is generated for each user, the printer driver 23 may access each setting, confirms that this setting file is a file of the user to which the administrator authority is set, and may refer to the setting information corresponding to the setting item may be referred.

When the printer driver 23 determines that the composing information is commonly used by users, the setting screen is set in such a way that the composing information is unselectable (at OP 16). The setting content to be set in this setting screen displays that the selection item of the composing information is unselectable in the setting screen or that the selection item is non-displayed. On the other hand, when the printer driver 23 determines that the composing information is not commonly used by users, the printer driver 23 adds, as a choice, identification information indicating the composing information created by the current login user, and also adds, as choice, identification information indicating the composing information created by the user to which the administrator authority is set (at OP 17). Therefore, in this case, the setting screen includes, as choice, the identification information of the composing information created by the administrator and the user, respectively. That is, even though the user to which the user authority is set does not create the composing information, the composing information created by the user to which the administrator authority is set becomes selectable. Consequently, the user may easily select the composing information.

The printer driver 23 displays the setting screen that is set according to the above-described processing on the screen of the display 14 (at OP 18).

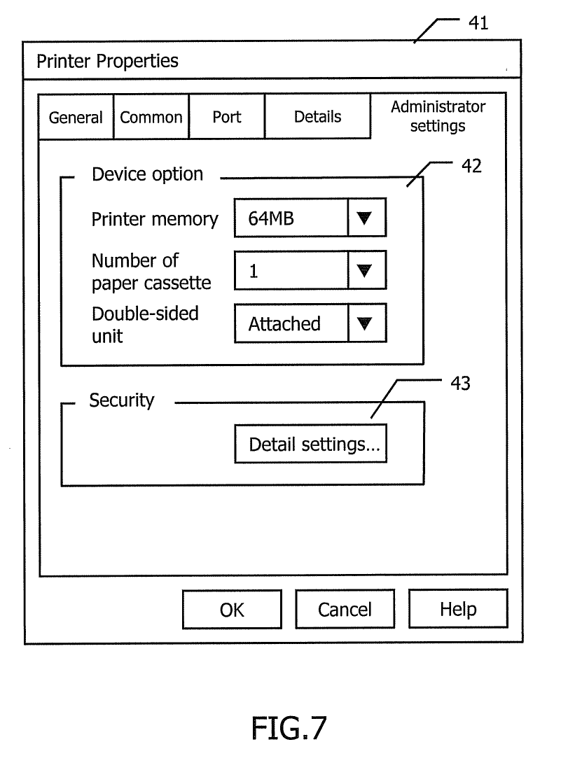

FIG. 7 to FIG. 9 are examples of setting screen used for a print setting under an administrator authority in an information processing apparatus according to an embodiment. The setting screen illustrated in these FIGs is displayed by, for example, the printer driver 23 when a display instruction of the print setting screen is given by the user to which the administrator authority is set.

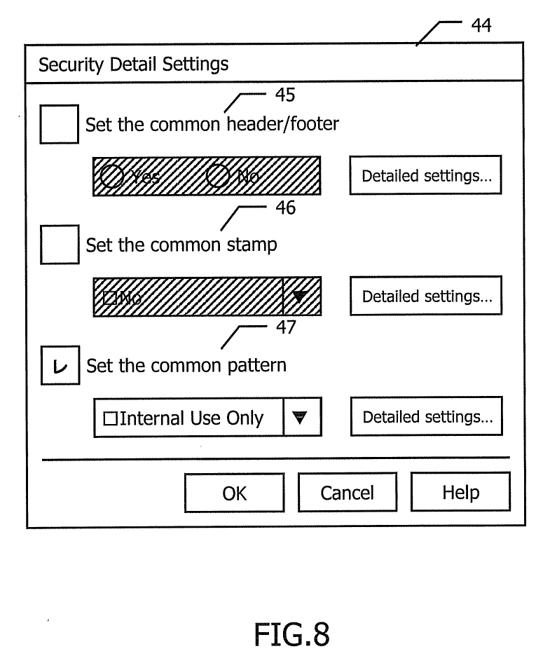

The setting screen 41 of FIG. 7 displays setting items 42 for setting(s) related to device option of the printer 18 and a detail setting button 43 for displaying a setting screen 48 for detail settings of security. When receiving a selection instruction of the detail setting button 43 by using the input device 15 by the user, the printer driver 23 displays the setting screen 48 illustrated in FIG. 8.

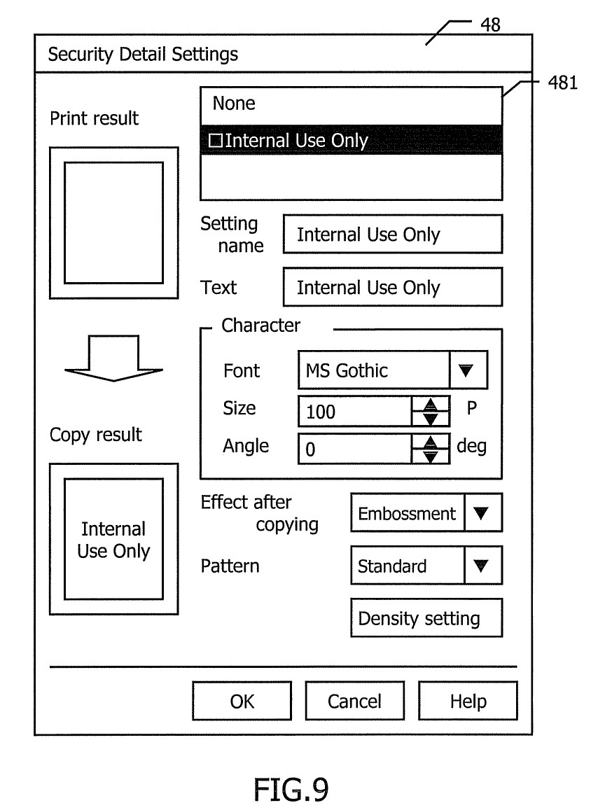

The setting screen 44 of FIG. 8 displays setting items for detail settings of security. An embodiment handles the composing information as security relevant information. Based on the setting item and the content specified in the setting screen 44, the printer driver 23 processes to print the print data composed by the data to be printed and the composing information. The setting items of FIG. 8 includes a setting item 45 concerning header/footer printing, and a setting item 46 concerning stamp printing, and a setting item 47 concerning pattern printing (watermark printing). The display content of the setting screen of FIG. 8 specifies setting in which the function of the setting item 47 is enabled, and each user uses the common pattern (watermark information) at the time of the printing processing. In such a situation, when receiving a selection instruction of the detail setting button of the setting item 47 using the input device 15 by a user, the printer device 23 displays a setting screen 48 illustrated in FIG. 9. Since the functions of the setting item 45 and the setting item 46 are not enabled, the printer driver 23 displays the setting screen 44 in such a way that the detail setting concerning these setting items is gray-out displayed, so that the user may not select the item.

The setting screen 48 of FIG. 9 provides choice of the composing information used for pattern printing and display for inputting and changing each setting information of the composing information. The upper part of the setting screen 48 is an area 481 displaying a list of the composing information. When a user selects certain identification information from the identification information displayed in this area 481 by using the input device 15, the printer driver 23 reads each setting information of the composing information indicated by the identification information from the setting file, and displays the information corresponding to each display item in the screen. In the screen display example of FIG. 9, the composing information indicating that the identification information (setting name) is “Internal Use Only” is selected. Each setting information of this composing information is displayed according to each item.

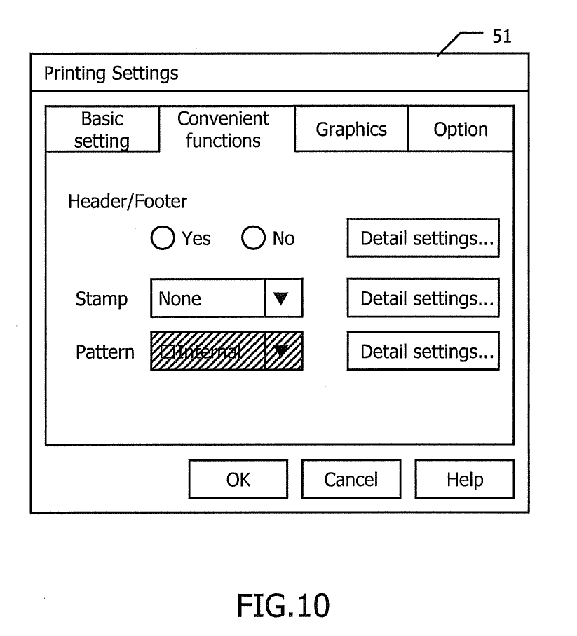

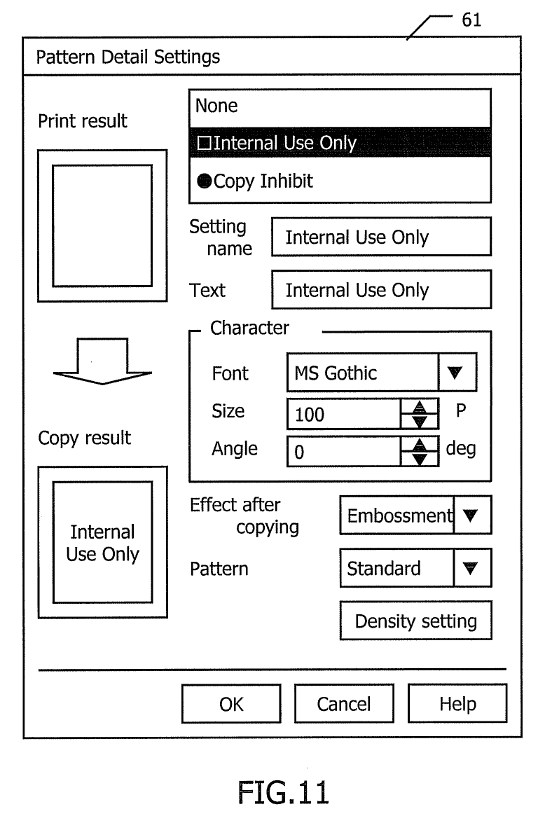

FIG. 10 and FIG. 11 are examples of setting screen used for print setting under a user authority in an information processing apparatus according to an embodiment. The setting screen illustrated in these diagrams is displayed by, for example the printer driver 23 when a display instruction is given by the user to which the user authority is set.

The setting screen 51 of FIG. 10 displays, as a useful function, a setting item group used for detail settings of security. Based on the setting item specified in the setting screen 51 and the content, the printer driver 23 processes to print the print data composed by the data to be printed and the composing information. Since each setting item is the same as the setting item group in the setting screen 44 of FIG. 8, the detailed description is omitted.

However, the printer driver 23 controls the display of the setting screen 51 of FIG. 10 according to the setting item in the setting screen 44 of FIG. 8. The printer driver 23 refers to the above-described management file to confirm existence or non existence of the setting item, in the setting screen 44 of FIG. 8, in which the administrator sets the composing information to be commonly used by users. When the printer driver 23 recognizes the setting item in which the composing information to be commonly used by users, the printer driver 23 displays the setting screen 51 in such a way that the item in the setting screen 51 corresponding to this item is grayed-out (inaccessible), so that a user may not change the setting. Since the functions of the setting screen 44 and the setting item 47 are enabled in the setting screen of FIG. 8, the printer driver 23 displays the setting screen 51 in such a way that the item corresponding to the setting item 47 is grayed-out as illustrated in FIG. 10. The printer driver 23 reads out, from the management file, that the composing information, “Internal Use Only”, is selected as the setting content of the setting item 47 in the setting screen 44 of FIG. 8. The printer driver 23 displays the setting screen 51 in such a way that the item is gray-out displayed in a state that the composing information, “Internal Use Only”, is used. By such processing, even though the user to which the user authority is set does not select the composing information, the document instructed to be printed is added with the composing information and then printed.

FIG. 11 illustrates a setting screen 61 displayed, in the setting screen of FIG. 10, by the printer driver 23 after the detail setting of pattern printing is instructed by a user when the user to which the administrator authority is set does not set the common use of the composing information. While the setting screen 61 is substantially the same as the setting screen 48 of FIG. 9, the list displays of the composing information are different. The setting screen 48 of FIG. 9 displays only the identification information of the composing information created by the user to which the administrator authority is set. On the other hand, the setting screen 61 of FIG. 11 displays not only the composing information created by the user to which the user authority is set, but also the identification information of the composing information created by the user to which the administrator authority is set. The setting screen 61 of FIG. 11 displays, as the composing information to be selectable, the composing information, “Internal Use Only”, created by the user to which the administrator authority is set and the composing information, “Copy Inhibit”, created by the user to which the user authority is set. This allows the user to which the user authority is set to use not only the composing information created by the user himself/herself, but also the composing information created by the user to which the administrator authority is set.

The above-described embodiment has described the example of printing processing as output processing. The above-described embodiment is also applicable to displaying processing. In such a case, the output device is the display 14, not the printer 18.

Next, other embodiment(s) will be described. While above-described embodiment uses the access authority level of the user which uses one information processing apparatus, an embodiment uses a level set to a plurality of information processing apparatuses.

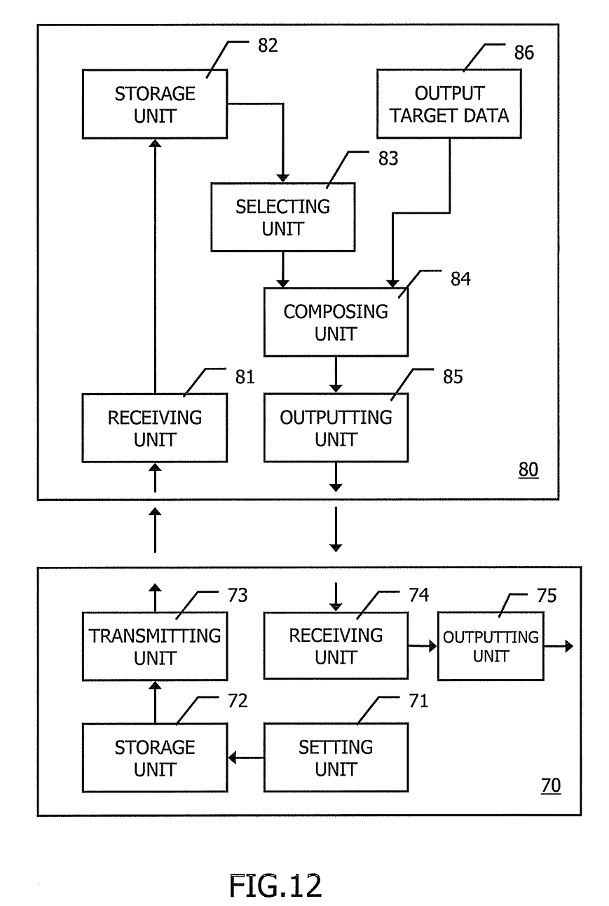

FIG. 12 is a configuration diagram of a system according to the other embodiments. The present system includes a first information processing apparatus 70 as a server and a second information processing apparatus 80 as a client. The first information processing apparatus 70 and the second information processing apparatus 80 basically have the basic hardware configuration for the information processing apparatus illustrated in FIG. 3. The printer is connected to the first information processing apparatus 70. The second information processing apparatus 80 is connected to the first information processing apparatus 70 through the communication line by a network adaptor, and employs a mode in which the printer 18 connected to the first information processing apparatus 70 is used. The first information processing apparatus 70 and the second information processing apparatus 80 include an OS and a printer driver of the software configuration illustrated in FIG. 4, respectively. An application program operates on the second information processing apparatus 80. The printer driver of the first information processing apparatus 70 and the printer driver of the second information processing apparatus 80 perform printing processing in corporation with each other. In the first information processing apparatus 70, the administrator operates to change the setting information concerning the printer 18. Therefore, the first information processing apparatus 70 has a higher level than that of the second information processing apparatus 80.

As illustrated in FIG. 12, the first information processing apparatus 70 includes a setting unit 71, a storage unit 72, a transmitting unit 73, a receiving unit 74, and an outputting unit 75. The second information processing apparatus 80 includes a receiving unit 81, a storage unit 82, a selecting unit 83, a composing unit 84, and an outputting unit 85.

Each configuration of the first information processing apparatus 70 will be described below. The setting unit 71, the transmitting unit 73, the receiving unit 74, and the outputting unit 75 are achieved by the printer driver performed by the CPU. The storage unit 72 corresponds to a non-volatile storage device such as an HDD or portable media. The setting unit 71 displays the above-described setting screen illustrated in FIG. 7 to FIG. 9, and allows the administrator to enter the setting information corresponding to each setting item. The setting unit 71 stores, in the storage unit 72, the setting information entered by the setting screen as a setting file and a management file. The transmitting unit 73 transmits the composing information stored in the setting file generated by the administrator to the second information processing apparatus 80 through the communication line. Furthermore, the transmitting unit 73 transmits the identification information of the composing information that is set to be commonly used to the second information processing apparatus 80 through the communication line.

Here, each configuration and processing of the second information processing apparatus 80 will be described. The receiving unit 81, the selecting unit 83, the composing unit 84, and the outputting unit 85 are achieved by the printer driver performed by the CPU. The storage unit 82 corresponds to a non-volatile storage device such as an HDD or portable media.

The receiving unit 81 receives identification information of the composing information that is set to be commonly used with the composing information transmitted from the transmitting unit 73 of the first information processing apparatus 70, and stores the identification information in the storage unit 82. At the time of reception of the output target data 86 generated by the application program as a trigger, the selecting unit 83 refers to the identification information of the composing information, stored in the storage unit 82, which is set to be commonly used, and then selects the composing information indicated by the identification information. The composing unit 84 receives the output target data 6 and the composing information selected by the selecting unit 83, and then composes the data and the information to generate composed data. The outputting unit 85 transmits the composed data generated by the composing unit 84 to the first information processing apparatus 70 through the communication line.

Once again, description will be made of processing of the first information processing apparatus 70. The receiving unit 74 of the first information processing apparatus 70 receives the composed data transmitted from the outputting unit 85 of the second information processing apparatus 80, and then supplies the composed data to the outputting unit 75. The outputting unit 75 transmits the received composed data to the printer connected to the second information processing apparatus 80, and makes a print request.

According to the above-described system configuration, the composing information set by the first information processing apparatus 70 is used in the second information processing apparatus 80. Thus, the composing information may be easily selected. Since the second information processing apparatus 80 adds the composing information without depending on the setting by the user of the second information processing apparatus 80, it is possible to prevent confidential documents from being printed without being added with the composing information.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention, the scope of which is defined in the claims and their equivalents.

What is claimed is:

1. An information processing apparatus in which at least either a first access authority at a first level or a second access authority at a second level that is higher than the first level, comprising:
a first storage unit that stores authority information indicating an access authority level of a first user;
a second storage unit that stores composing information in association with a second user;
a selecting unit that refers to the authority information stored in the first storage unit and selects the composing information stored in the second storage unit in association with the second user to which the second access authority is set when the authority information indicates the first access authority;
a composing unit that composes the composing information selected by the selecting unit and output target data generated based on an output instruction by the first user; and
an outputting unit that outputs composed data of processing results by the composing unit.

2. The information processing apparatus claim 1, wherein the selecting unit comprises:
a display controlling unit that displays, in a display device, a screen displaying a list of identification information indicating the composing information, and
a selection controlling unit that selects, as a composing target by the composing unit, the composing information indicated by the identification information selected from the list by a selection operation by the first user using an input device,
wherein the selection controlling unit executes control in such a way that the first user may not perform the selection operation of identification information from the list of the identification information when the authority information indicates the first access authority.

3. The information processing apparatus according to claim 2, wherein the selection controlling unit prevents display of the list of the identification information by the display controlling unit when the authority information indicates the first access authority.

4. The information processing apparatus according to claim 2, wherein the list of the identification information indicating the composing information includes:
a first identification information indicating first composing information stored in the second storage unit in association with the second user to which the second access authority is set, and
a second identification information indicating a second composing information stored in the second storage unit in association with the first user to which the first access authority is set.

5. A computer-readable recording medium storing an output control program causing a computer in which at least either a first access authority at a first level or a second access authority at a second level that is higher than the first level may be set according to a user, to execute operations, comprising:
referring to a first storage unit that stores authority information indicating an access authority level of a first user of an information processing apparatus;
selecting composing information stored in a second storage unit in association with a second user to which a second access authority is set from the second storage unit that stores composing information in association with the second user when the authority information indicates the first access authority;
composing the selected composing information and output target data generated based on an output instruction by the first user; and
outputting composed data of processing results by composition.

6. The computer-readable recording medium according to claim 5, wherein the selecting comprises:
display controlling a screen displaying a list of identification information indicating the composing information in a display device, and
selection controlling the composing information indicated by the identification information selected from the list by selection operation by the first user using an input device,
wherein the selection controlling controls in such a way that the first user may not perform selection operation of identification information from the list of the identification information when the authority information indicates the first access authority.

7. The computer-readable recording medium according to claim 6, wherein the selection controlling prevents display of the list of the identification information by the display controlling when the authority information indicates the first access authority.

8. The computer-readable recording medium according to claim 6, wherein the list of the identification information indicated by the composing information includes:
a first identification information indicating a first composing information stored in the second storage unit in association with the second user to which the second access authority is set, and
a second identification information indicating a second composing information stored in the second storage unit in association with the first user to which the first access authority is set.

9. An output control method that is performed in an information processing apparatus, comprising:
assigning a first access authority at a first level or a second access authority at a second level that is higher than the first level to users;
referring to a first storage unit that stores authority information indicating an access authority level of a first user of the information processing apparatus;
selecting composing information stored in a second storage unit in association with a second user to which the access authority is set from the second storage unit storing composing information in association with the second user when the authority information indicates the first access authority;
composing the selected composing information and output target data generated based on an output instruction by the first user; and
outputting composed data of processing results by the composing.

10. A system that includes a first information processing apparatus and a second information processing apparatus, the system comprising:
the first information processing apparatus including:
a setting unit that specifies composing information to be used for composition processing;
a storage unit that stores the composing information;
a transmitting unit that transmits the composing information to the second information processing apparatus;
a receiving unit that receives composed data from the second information processing apparatus; and
an outputting unit that outputs the received composed data,
the second information processing apparatus including:
a receiving unit that receives the composing information transmitted from the first information processing apparatus;
a storage unit that stores received composing information;
a composing unit that composes selected composing information and output target data generated based on an output instruction by a user; and
an outputting unit that outputs composed data of processing results by the composing unit to the first information processing apparatus.

11. A method of controlling an output, comprising:
determining an access level of a user; and
applying predetermined composing data to an output target when the determining indicates a first access level and displaying an option prompting a selection of composing data by the user when the determining indicates a second access level.
